(19) United States
(12) Patent Application Publication
(10) Pub. No.: US 2013/0055863 A1
(43) Pub. Date: Mar. 7, 2013

(54) SAFETY CUTTING DEVICE AND ASSOCIATED METHODS

(71) Applicant: Wayne Winton, Fruita, CO (US)

(72) Inventor: Wayne Winton, Fruita, CO (US)

(21) Appl. No.: 13/225,093

(22) Filed: Sep. 2, 2011

(51) Int. Cl. B26B 29/02; B26D 3/00; B26B 1/08; B26B 3/00; B26B 1/04; B26B 1/02

(52) U.S. Cl. 83/13; 30/151; 30/161; 30/155; 30/162; 30/289; 30/294

(57) ABSTRACT

A safety cutting device for use in removing portions of an article from an injured person comprises a housing body and a blade, moveably coupled to the housing body. The blade has at least a spine and a cutting edge. The housing body includes an opening formed therein in which at least a portion of the blade can be stored when not in use. A safety guard is coupled to or formed integrally with a portion of the edge of the blade, the safety guard having a substantially smooth outer edge and being sized and shaped to allow the spine of the blade to safely slide along a body part of an injured person's body while restricting the cutting edge of the blade from contacting the injured person's body.

### BACKGROUND OF THE INVENTION

1. Field of the Invention

The present invention relates generally to the field of cutting devices. The invention relates more particularly to cutting devices for use in quickly removing clothing, gear or equipment from injured persons.

2. Related Art

In emergency situations involving an injured person, it is oftentimes necessary to remove articles of clothing, equipment, gear, etc., that are being worn by the injured person to allow medical personnel to access injured areas of the person. For example, if a person has a broken or lacerated leg, then some or all of the persons' apparel or gear that normally covers the leg should be removed to allow medical personnel to access the injury. However, it is often the case that, due to the injury, the situation presents the least optimal conditions under which such apparel or gear can be removed, as doing so may further injure the individual, or the injury may render the person's body unfit to be moved in ways necessary to remove the apparel or gear.

For this reason, it is often the case that medical personnel cut or tear apparel or gear away from the injured area to provide access to the injury without further exacerbating the injury. In some cases, this removal of apparel or gear can be done with so-called “trauma shears,” which are simply scissors with angled cutting blades. While such scissors have proved at least partially effective, they suffer from a number of disadvantages. First, in many emergency situations, the removal of apparel or gear must be (or is ideally) done very quickly. If removal consumes too much time, the patient can suffer unnecessarily, or worse, can potentially “bleed out” while the medical personnel are attempting to access the injury. Trauma shears have not proven to be sufficiently fast in such situations.

Second, when the injured person is wearing heavy equipment or gear, as is often the case in industrial environments such as mines, construction projects, etc., trauma shears may not provide sufficient force to allow medical personnel to remove the heavy equipment or gear. A medical technician can be very frustrated to have access to only a typical pair of trauma shears when trying to remove heavy-duty apparel, equipment or gear (or portions thereof) from an injured person.

### SUMMARY OF THE INVENTION

In accordance with one aspect of the invention, a safety cutting device for use in removing portions of an article from an injured person is provided, including a housing body and a blade, moveably coupled to the housing body. The blade can have at least a spine and a cutting edge. The housing body can include an opening formed therein in which at least a portion of the blade can be stored. A safety guard can be coupled to or formed integrally with a portion of the edge of the blade, the safety guard having a substantially smooth outer edge and being sized and shaped to allow the spine of the blade to safely slide along a body part of an injured person's body while restricting the cutting edge of the blade from contacting the injured person's body.

In accordance with another aspect of the invention, a safety cutting device for use in removing portions of an article from injured persons is provided, including a handle and a blade, extending from the handle and having a spine with a rear surface and a cutting edge opposing the rear surface. A safety guard can be coupled to or formed integrally with a portion of the blade, the safety guard having a substantially smooth outer edge and being sized and shaped to allow the spine of the blade to safely slide along a body part of an injured person while restricting the cutting edge of the blade from contacting the injured person's body. A cutting area can be defined adjacent the cutting edge, the cutting area being configured to receive a portion of an article worn by an injured person to allow the cutting edge to cut at least a portion of the article adjacent the body part. The cutting device can be devoid of any structure extending beyond the cutting edge in a plane extending from the spine of the blade through the cutting edge of the blade, to ensure that no portion of the cutting device other than the cutting edge contacts an upper surface of the article.

In accordance with another aspect of the invention, a method of removing at least a portion of an article worn by a person from a location immediately adjacent a body part of the person is provided, including: grasping a handle of a cutting device; engaging the portion of the article with a cutting edge of a blade of the cutting device;

engaging the body part of the person with a safety guard coupled to or formed integrally with the blade of the cutting device; and pushing the cutting device forwardly relative to the handle to thereby slide the safety guard along the body part of the person while cutting through the article with the cutting edge of the blade.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a side view of a safety cutting device in accordance with an embodiment of the invention;

FIG. 2 is a top view of the safety cutting device of FIG. 1;

FIG. 3 is a more detailed, perspective view of the cutting device of FIG. 1;

FIG. 4 is a schematic, partially sectioned view of an article of apparel being removed from a patient's body with the safety cutting device of FIG. 1;

FIG. 5 is a side view of another safety cutting device in accordance with an aspect of the invention, shown in a closed orientation; and

FIG. 6 is a side view of the safety cutting device of FIG. 5, shown in an open orientation.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Definitions

As used herein, the singular forms “a” and “the” can include plural referents unless the context clearly dictates otherwise. Thus, for example, reference to “a blade” can include one or more of such blades.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

As used herein, the term “article” is to be understood to refer to a variety of objects such as clothing, apparel, equipment, gloves, footwear, personal protective gear, safety harnesses (including seat belts), etc., that can be worn by, or are secured about, an individual. Typically, the removal of such article (or the partial removal of, or the removal of portions of the article) is desirable when attending to injuries sustained by the individual. For example, if a person sustained a laceration in his or her leg, medical personnel will generally find it necessary to remove (or remove portions of) pants, coveralls, aprons, or any type of article that impedes access to the laceration in order to properly treat the laceration.

Invention

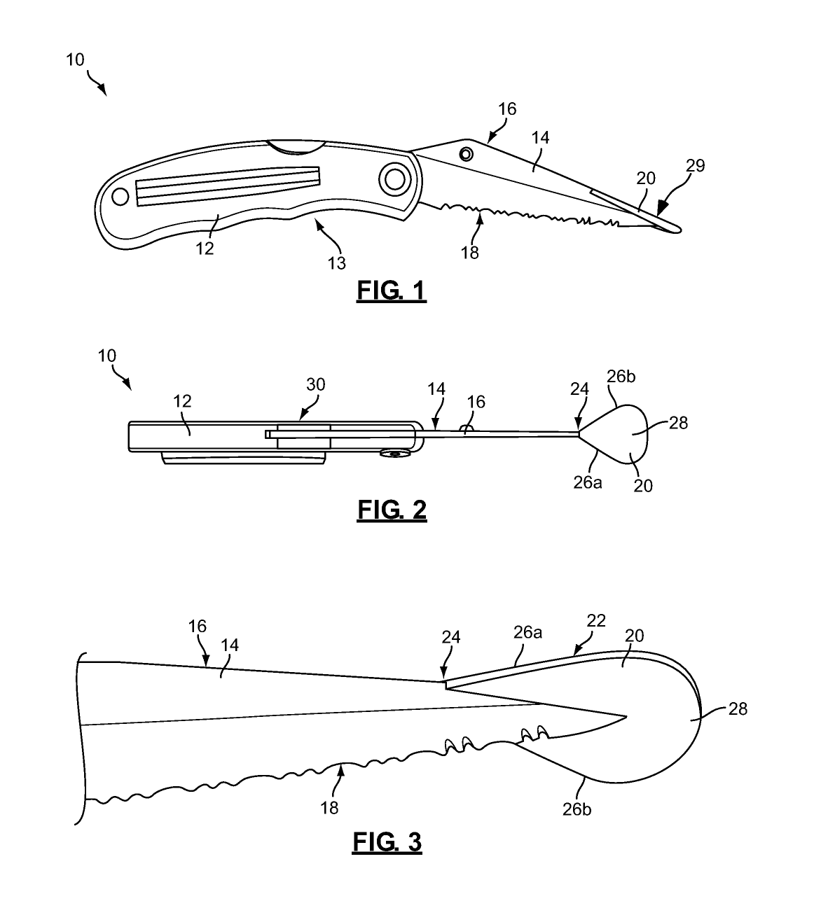

The present invention relates to cutting devices that can be safely used to quickly remove apparel, gear, equipment, etc. (or portions of said apparel, gear, equipment) from injured persons. Such apparel, gear, equipment, footwear, etc., will be referred to herein by the general term “article.” As shown generally by example in the figures, with particular reference to FIGS. 1-4, in one aspect of the invention, a safety cutting device 10 is provided for use in removing portions of an article (shown by example at 40 in FIG.

4) from an injured person (a portion of which is shown by example at 50 in FIG. 4). The cutting device can include a housing body or handle 12, and a blade 14. In one aspect, the blade 14 can be moveably coupled to the housing body, to allow the blade to rotate or slide relative to the housing body or handle (as discussed in more detail below). The blade can include at least a spine 16 and a cutting edge 18.

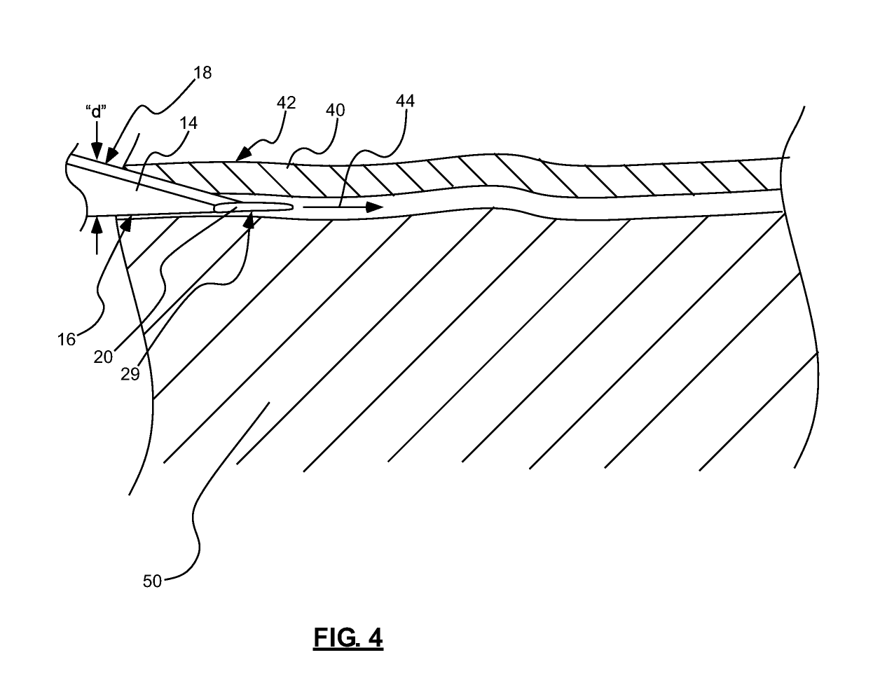

The cutting device 10 can include a safety guard 20 that can be coupled to or formed integrally with a portion of the blade. As best seen in FIG. 3, in one aspect the safety guard 20 can include a substantially smooth outer edge 22 and can be sized and shaped to allow the spine 16 of the blade to safely slide along a body part (50 in FIG. 4) of an injured person's body while restricting the cutting edge 18 of the blade from contacting the injured person's body.

The cutting device can thus be formed of relatively rigid materials, and can be provided with a very sharp cutting edge 18. Due to these attributes, the cutting device can very quickly cut through even the toughest of articles (e.g., heavy clothing, coats, coveralls, durable harness straps, thick leather used in safety boots, multiple layers of clothing, and the like). While using such a blade to remove one or more articles from an already injured person may have conventionally been perceived as somewhat dangerous, the safety guard 20 allows the use of such blades with a great deal of speed and a high degree of safety. FIG. 4 illustrates one exemplary manner of utilizing the safety cutting device. In this example, the spine 16 of the blade 14 can be rested against a body part 50 of an injured person (e.g., against an arm, leg or torso of the injured person), with the cutting edge 18 of the blade in contact with an undersurface of the article 40 that is to be removed from the person. As the spine is rested against the body part, the safety guard is also rested against the body part, and lies relatively flat against the injured person's skin.

An operator can then, very quickly and easily, push and/or slide the safety guard 20 along the injured person's skin, which results in the cutting edge 18 slicing though the article 40 to expose the body part 50 beneath the article. In this manner, even very large portions of articles such as coveralls, safety boots, etc., can quickly be removed from an area adjacent an injured portion of the person's body. The safety guard 20 allows rapid and forceful use of the cutting blade because the guard covers the otherwise very sharp tip of the blade, and limits or restricts the blade from twisting relative to the skin of the injured person (thereby limiting or restricting the cutting edge from cutting the skin of the injured person).

As best appreciated from FIGS. 2 and 3, in one aspect of the invention, the safety guard can include a profile that includes a base 24 and a pair of sidewalls 26a, 26b that angle outwardly from the spine 16 of the blade and transition into a bulbous head 28. The bulbous head can include a pair of shoulders or flanges that are arranged substantially symmetric relative to the spine of the blade. In this manner, the operator of the cutting device 10 is substantially prevented from twisting the blade as he or she slides it along the skin of the injured person, preventing him or her from injuring the person with the cutting edge of the blade. The bulbous shape of the head 28 also aids in preventing the head from becoming “caught” on, or “snagging,” the article during the cutting process, which could otherwise negatively affect the cutting efficiency.

A contact surface 29 (FIGS. 1 and 4) can be substantially planar (e.g., flat) so as to further aid in preventing the blade from twisting from the desired orientation while being used. While the surface area of the contact surface can vary, in one embodiment, the surface area is around 0.5 in² to around 1.5 in². In one embodiment, the surface area is about 0.8 in². In another, surface area is about 1 in². The present inventor has found that this amount of surface area (in the proper configuration) is sufficient to maintain the blade in the desired orientation while not adding considerably to the expense or weight of the cutting device as a whole.

While the safety guard 20 is shown in the figures having a substantially bulbous configuration, it is to be understood that a variety of alternate configurations can also be utilized. For example, a pair of wing-like shoulders or flanges can extend outwardly from the tip of the blade 14 and serve the same purpose. Also, while the safety guard 20 is shown in the figures as covering, or being attached to, or formed in place of, the otherwise very sharp tip of the knife blade, in some embodiments, the safety guard can be located more centrally along the length of the blade (in which case, the tip of the blade would likely be very blunt, to prevent it from engaging the user's skin). Locating the safety guard in a more central location may improve the stabilizing effect of the wings or the shoulders of the guard to more effectively prevent twisting of the blade relative to the body part of the injured person.

The safety guard 20 can be formed of a variety of materials, and can be coupled to the blade 14 in a variety of manners. In one aspect, the safety guard can be formed of a metallic material, a polymeric material, a stiff cloth material, etc., and can be bonded, welded, attached via mechanical fasteners, etc., to the blade. In another embodiment, the safety guard 20 can be integrally formed with the blade, during casting, for example, of the blade material.

In one aspect of the invention, the blade 14 can be moveably coupled to the body housing or handle 12. In this manner, the blade can include at least two configurations: i) an extended orientation, wherein the blade is extended from the housing body for use as a cutting device; and ii) a stored orientation, wherein the cutting edge of the blade is substantially fully covered by the housing body for safe storage of the blade. The blade can be moveable relative to the body or handle in a variety of manners. In the aspect shown in FIGS. 1 through 3, the cutting device operates very similarly to a typical folding “pocket knife:” when extended into the “open” position (shown in FIGS. 1-3), the blade can be locked via known locking mechanisms to prevent inadvertent closure or folding of the knife.

When it is desired to store or transport the cutting device, catch 30 (FIG. 2) can be disengaged to allow the blade 14 to fold upon (and partially into) the body housing or handle 12. The housing or handle can include an opening (such as an elongate slot, the position of which is indicated at 13 in FIG. 1) formed therein in which at least a portion of the blade can be stored. In this manner, when the cutting device is in the stored or “closed” configuration, the device can be safely carried in a pocket or gear box without any portion of the very sharp cutting edge being exposed.

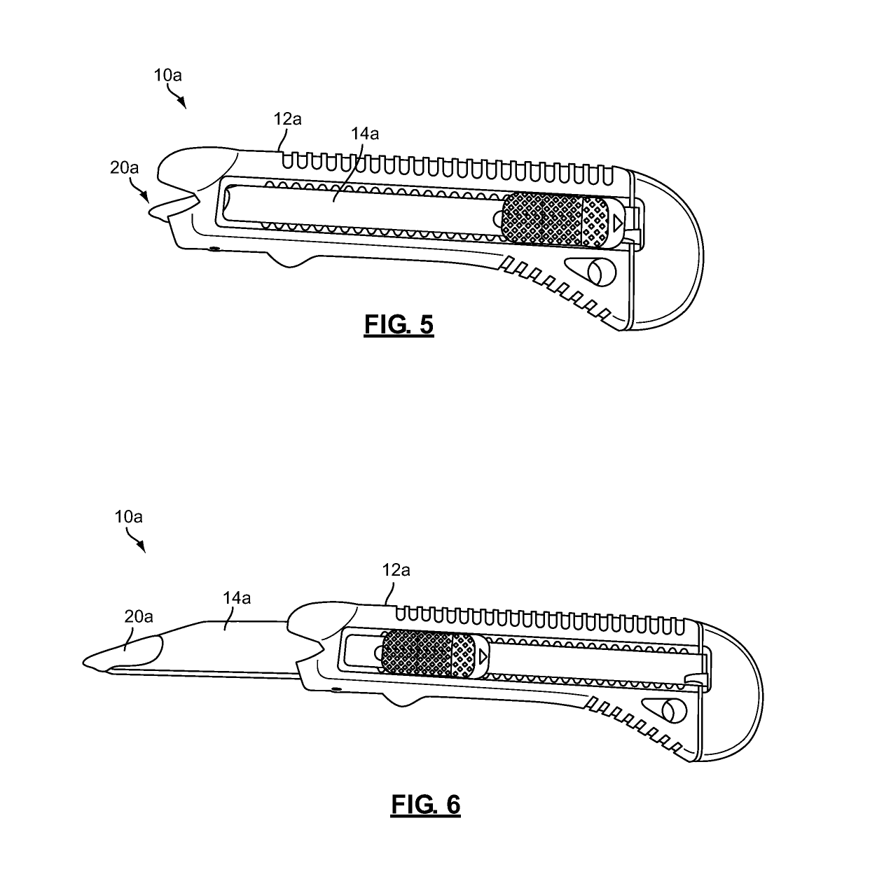

While the embodiment of the invention shown in FIGS. 1 through 3 includes a blade 14 that is rotatably coupled to the handle or housing 12, the embodiment illustrated in FIGS. 5 and 6 includes a blade 14a that is slidably moveable relative to housing body 12a. This embodiment can also include known locking structure that allows the blade to be extended into a position for use, and retracted into a storage position for safe transport and storage of the knife. This embodiment can also include safety guard 20a.

While the two examples shown, 10 and 10a, include cutting devices that have blades 12, 12a that are moveable relative to housings 12, 12a, in one aspect of the invention, the blade is fixed relative to a handle (e.g., there is no structure that allows the blade to be rotated or slid relative to the handle). In this manner, the cutting device can be stored within a sheath or scabbard, and removed for use when needed. Depending upon the specific example being discussed herein, the terms “housing” and “handle” can sometimes be used interchangeably to refer to the portion of the cutting device that is grasped by a user when wielding the cutting device.

The cutting edge 18 of the blade 14 can be configured in a number of manners. In the example shown in FIGS. 1-3, the cutting edge can include serrations to aid in cutting materials where such serrations are advantageous. Also, in one aspect of the invention, the cutting edge 18 can include a double-edged cutting profile (e.g., the cutting edge is symmetric, and tapers downwardly on both sides from the very sharp edge itself). This can also aid in maintaining the cutting blade in an orientation that is perpendicular to the article being cut (that is, the blade is maintained at substantially 90 degrees relative to the article, while the safety guard is maintained substantially parallel to the skin of the injured person).

In one embodiment of the invention, possibly best appreciated from FIG. 4, the cutting device 10 (when in the extended orientation) can be devoid of any structure extending beyond the cutting edge 18 in a plane that extends from the spine 16 of the blade 14 through the cutting edge 18 of the blade. In this manner, no portion of the cutting device other than the cutting edge contacts an upper surface 42 of the article. Many conventional cutting systems, such as shears or lanyard cutters, include structure that tends to get caught on, or snagged by, the article being cut, which can significantly increase the time it takes to cut through an article. The present invention provides a sufficiently sharp blade, and effective skin protection mechanism, so that not only is no such auxiliary structure needed, it is intentionally avoided to prevent slowing of the cutting process. The cutting device can include a configuration in which there is no structure that extends or exists immediately adjacent the plane that extends from the spine through the cutting edge.

While not so required, in one aspect of the invention (shown in FIG. 4), the blade 14 can include a depth “d” defined between the cutting edge 18 and the spine 16. The depth can taper from a smallest depth adjacent the safety guard (or adjacent a tip of the blade, where applicable) to a larger depth distal the safety guard (e.g., further from the tip toward the handle or housing 12). The tapering depth can allow the cutting edge to cut the article as the cutting device is pushed between a body part of an injured person and the article worn by the injured person. In other words, the blade 14 can simply be pushed by a user and compressed between the body part of the injured person and the article to be cut, and the wedge-shaped taper can cause the cutting edge to be forced through the article as a result of the pushing motion. The safety guard maintains the blade in the proper orientation as the wedge-shaped taper is forced between the article and the user.

In addition to the structure discussed above, the present invention also provides a method of removing at least a portion of an article worn by a person from a location immediately adjacent a body part of the person. The method can include: grasping a handle of a cutting device; engaging the portion of the article with a cutting edge of a blade of the cutting device; engaging the body part of the person with a safety guard coupled to or formed integrally with the blade of the cutting device; and pushing the cutting device forwardly relative to the handle to thereby slide the safety guard along the body part of the person while cutting through the article with the cutting edge of the blade.

As used herein, the term “pushing the cutting device forwardly relative to the handle” is to be understood to refer to a motion in which the cutting device is moved in a direction lead by the safety guard (or by the tip of the knife) and trailed by the handle or housing of the cutting device. This motion is much easier for most operators accomplish, and is safer in that the cutting edge is typically travelling away from the user during the cutting operation. This pushing motion is shown by directional indicator 44 shown in FIG. 4.

The blade of the cutting device used in the method can be moveably coupled to the handle, and the method can further comprise extending the blade of the cutting device into a useable position prior to engaging the portion of the article with the cutting edge.

The blade of the cutting device used in the method can be rotatably coupled to the housing body, and extending the blade can further include rotating the blade from a storage position into the extended position.

The cutting device used in the method can also include a locking mechanism, and the method can further include locking the blade in the extended position after rotating the blade from the storage position into the extended position.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the examples.

I claim:

1. A safety cutting device for use in removing portions of an article from an injured person, comprising:
a housing body;
a blade, moveably coupled to the housing body, the blade having at least a spine and a cutting edge;
the housing body including an opening formed therein in which at least a portion of the blade can be stored; and
a safety guard, coupled to or formed integrally with a portion of the edge of the blade, the safety guard having a substantially smooth outer edge and being sized and shaped to allow the spine of the blade to safely slide along a body part of an injured person's body while restricting the cutting edge of the blade from contacting the injured person's body.

2. The device of claim 1, further comprising a locking mechanism operable to lock relative movement between the blade and the housing body.

3. The device of claim 2, wherein the blade is rotatably coupled to the housing body.

4. The device of claim 1, wherein the opening comprises an elongate slot formed in the housing body, and wherein the blade can be rotated relative to the housing body such that at least a portion of the cutting edge of the blade is stored within the elongate slot formed in the housing body.

5. The device of claim 1, wherein the blade is slidably moveable relative to the housing body.

6. The device of claim 1, wherein the safety guard has a profile that includes:
a base having a pair of sidewalls that angle outwardly from the spine of the blade and transition into a bulbous head, the bulbous head having a pair of flanges substantially symmetric relative to the spine of the blade.

7. The device of claim 1, where the cutting edge includes a double-edged cutting profile.

8. The device of claim 1, wherein the blade includes at least two orientations:
an extended orientation, wherein the blade is extended from the housing body for use as a cutting device; and
a stored orientation, wherein the cutting edge of the blade is substantially fully covered by the housing body for safe storage of the blade.

9. The device of claim 8, wherein:
the cutting device, when in the extended orientation, is devoid of any structure extending beyond the cutting edge in a plane extending from the spine of the blade through the cutting edge of the blade, to ensure that no portion of the cutting device other than the cutting edge contacts an upper surface of the article.

10. A safety cutting device for use in removing portions of an article from injured persons, comprising:
a handle;
a blade, extending from the handle and having a spine with a rear surface and a cutting edge opposing the rear surface;
a safety guard, coupled to or formed integrally with a portion of the blade, the safety guard having a substantially smooth outer edge and being sized and shaped to allow the spine of the blade to safely slide along a body part of an injured person while restricting the cutting edge of the blade from contacting the injured person's body; and
a cutting area defined adjacent the cutting edge, the cutting area being configured to receive a portion of an article worn by an injured person to allow the cutting edge to cut at least a portion of the article adjacent the body part; wherein
the cutting device is devoid of any structure extending beyond the cutting edge in a plane extending from the spine of the blade through the cutting edge of the blade, to ensure that no portion of the cutting device other than the cutting edge contacts an upper surface of the article.

11. The device of claim 10, wherein the safety guard has a profile that includes:
a base having a pair of sidewalls that angle outwardly from the spine of the blade and transition into a bulbous head, the bulbous head having a pair of flanges substantially symmetric relative to the spine of the blade.

12. The device of claim 10, where the cutting edge includes a double-edged cutting profile.

13. The device of claim 11, wherein the blade includes a depth defined between the cutting edge and the spine, and wherein the depth tapers from a smallest depth adjacent the safety guard to a larger depth distal the safety guard, the tapering depth allowing the cutting edge to cut the article as the cutting device is pushed between a body part of an injured person and the article worn by the injured person.

14. A method of removing at least a portion of an article worn by a person from a location immediately adjacent a body part of the person, comprising:
grasping a handle of a cutting device;
engaging the portion of the article with a cutting edge of a blade of the cutting device;
engaging the body part of the person with a safety guard coupled to or formed integrally with the blade of the cutting device; and
pushing the cutting device forwardly relative to the handle to thereby slide the safety guard along the body part of the person while cutting through the article with the cutting edge of the blade.

15. The method of claim 14, wherein the blade of the cutting device is moveably coupled to the handle; and further comprising extending the blade of the cutting device into a useable position prior to engaging the portion of the article with the cutting edge.

16. The method of claim 15, wherein the blade is rotatably coupled to the housing body, and wherein extending the blade comprises rotating the blade from a storage position into the extended position.

17. The method of claim 16, wherein the cutting device includes a locking mechanism, and further comprising locking the blade in the extended position after rotating the blade from the storage position into the extended position.

18. The method of claim 14, wherein the safety guard has a profile that includes:
a base having a pair of sidewalls that angle outwardly from the spine of the blade and transition into a bulbous head, the bulbous head having a pair of flanges substantially symmetric relative to the spine of the blade.

19. The method of claim 14, where the cutting edge includes a double-edged cutting profile.

20. The method of claim 14, wherein:
the cutting device, when in the extended orientation, is devoid of any structure extending beyond the cutting edge in a plane extending from the spine of the blade through the cutting edge of the blade, to ensure that no portion of the cutting device other than the cutting edge contacts an upper surface of the article.
